(19) United States
(12) Patent Application Publication
(10) Pub. No.: US 2025/0074408 A1
(43) Pub. Date: Mar. 6, 2025

(54) DRIVING SUPPORT SYSTEM

(71) Applicant: HONDA MOTOR CO., LTD., Tokyo (JP)

(72) Inventors: Makoto KATAYAMA, Tokyo (JP); Masao YOSHINAGA, Tokyo (JP); Chikashi IIZUKA, Tokyo (JP)

(21) Appl. No.: 18/820,201

(22) Filed: Aug. 29, 2024

(30) Foreign Application Priority Data
Aug. 31, 2023 (JP) 2023-141512

(51) Int. Cl. B60W 30/095; B60W 50/14; G06V 20/56

(52) U.S. Cl. CPC B60W 30/0956; B60W 50/14; G06V 20/588; B60W 2554/4041

(57) ABSTRACT

A driving support system 1 includes a surrounding information acquisition unit 81 that acquires surrounding information, an alert target recognition unit 85 that recognizes a following vehicle present in an alert region defined to be laterally behind the subject vehicle as an alert target, an alert control unit 86 that performs first alert control of alerting the rider of the subject vehicle about the presence of the alert target in a case where the alert target is recognized, and a course changing prediction unit 87 that predicts execution of course changing by the subject vehicle to be performed while the alert target is recognized. The alert control unit 86 performs second alert control with a higher alert intensity than the first alert control in a case where execution of the course changing is predicted by the course changing prediction unit 87 while the first alert control is performed.

This application is based on and claims the benefit of priority from Japanese Patent Application No. 2023-141512, filed on 31 Aug. 2023, the content of which is incorporated herein by reference.

### BACKGROUND OF THE INVENTION

### Field of the Invention

The present invention relates to a driving support system. More particularly, the present invention relates to a driving support system having a function of alerting a driver about the presence of another vehicle laterally behind a subject vehicle.

### Related Art

In recent years, endeavors have become more active to provide access to sustainable transport systems made in consideration of people who are in vulnerable situations among traffic participants. For realizing this, research and development for greatly improving the safety and convenience of traffic has been given attention through research and development related to various driving support functions.

A vehicle control device described in Patent Document 1displays a predetermined image on part of a mirror surface of a door mirror in a case where it is recognized that another vehicle is present in a predetermined region defined to be laterally behind a subject vehicle based on information acquired with a camera, a radar, or the like, so that a driver can be alerted to recognize the other vehicle approaching the subject vehicle. Such a driving support function is also called a blind spot information (BSI) function.

In recent years, a BSI function of performing alerting separately in two steps has also been known. In this case, a weak alert is issued in a case where another vehicle approaching from laterally behind a subject vehicle is initially recognized, and thereafter, a strong alert is issued in a case where a driver of the subject vehicle operates a turn signal to express his/her intention to perform lane changing. This can prevent the driver from performing lane changing to the other vehicle side without recognizing the presence of the other vehicle approaching from laterally behind.

Patent Document 1: Japanese Unexamined Patent Application, Publication No. 2019-49774

### SUMMARY OF THE INVENTION

FIG. 8 is a view illustrating a state in which a subject vehicle V which is a motorcycle traveling on a road 200 having two lanes on each side is going to overtake a preceding vehicle Va which is a four-wheeled vehicle. FIG. 8 also shows a case where a following vehicle Vb which is a motorcycle is traveling laterally behind the subject vehicle V on a road shoulder 209 of the road 200.

As illustrated in FIG. 8, a motorcycle (such as the subject vehicle V and the following vehicle Vb in FIG. 8, for example) is smaller in vehicle width and lighter in weight than a four-wheeled vehicle (the preceding vehicle Va in FIG. 8, for example) and can thus travel on the road shoulder 209. As illustrated by arrows in FIG. 8, the subject vehicle V which is a motorcycle can overtake the preceding vehicle Va along the road shoulder 209. However, the overtaking motion of the subject vehicle V as illustrated in FIG. 8 is not lane changing, and thus, a driver of the subject vehicle V in some cases changes course to the road shoulder 209 side without operating a turn signal.

With the conventional BSI function, a strong alert is issued on the condition that a turn signal is operated as described above. Therefore, a strong alert is not issued in the example illustrated in FIG. 8 even in a case where the following vehicle Vb has been recognized as an alert target by the BSI function loaded on the subject vehicle V. Thus, the following vehicle Vb traveling on the road shoulder 209 and the subject vehicle V which is going to enter the road shoulder 209 might come into contact with each other.

The present invention has an object to provide a driving support system that alerts a driver of a vehicle that can travel on a road shoulder about the presence of a following vehicle with an appropriate intensity, thereby enabling traffic safety to be improved.

(1) A driving support system according to the present invention includes a surrounding information acquirer configured to acquire surrounding information related to a state of surroundings of a subject vehicle, an alert target recognizer configured to, based on the surrounding information, recognize another vehicle present in an alert region defined to be laterally behind the subject vehicle as an alert target, an alert controller configured to, in a case where the alert target is recognized, perform first alert control of alerting a driver of the subject vehicle about a presence of the alert target, and a course changing predictor configured to, based on the surrounding information, predict execution of course changing by the subject vehicle to be performed while the alert target is recognized, in which the alert controller performs second alert control with a higher alert intensity than the first alert control in a case where execution of the course changing is predicted by the course changing predictor while the first alert control is performed.

(2) In this case, preferably, the course changing predictor predicts execution of the course changing based on the surrounding information in a case where it is recognized that a movement triggering factor that triggers a movement of the subject vehicle in a width direction is present ahead of the subject vehicle in a traveling direction.

(3) In this case, preferably, the driving support system further includes a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, in which the course changing predictor predicts that the subject vehicle will change course from the road shoulder region to the normal traveling region in a case where it is recognized that the traveling position is located in the road shoulder region and an obstacle as the movement triggering factor is present ahead of the subject vehicle in the traveling direction.

(4) In this case, preferably, the driving support system further includes a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, and a risk index calculator configured to, in a case where a preceding vehicle is present ahead of the subject vehicle in the traveling direction, calculate a risk index based on the surrounding information, the risk index decreasing as a risk that the subject vehicle will come into contact with the preceding vehicle increases, in which the course changing predictor predicts execution of the course changing in a case where the traveling position is located in the normal traveling region, the preceding vehicle as the movement triggering factor is present ahead of the subject vehicle in the traveling direction, and the risk index for the preceding vehicle is smaller than or equal to a predetermined threshold value.

(5) In this case, preferably, the driving support system further includes a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, in which the course changing predictor predicts execution of the course changing in a case where the traveling position is located in the normal traveling region, the movement triggering factor includes movement triggering factors, a preceding vehicle and a traffic light as the movement triggering factors are present ahead of the subject vehicle in the traveling direction, and a display mode of the traffic light represents no-entry or stop.

(6) In this case, preferably, the driving support system further includes a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, in which the course changing predictor predicts execution of the course changing in a case where the traveling position is located in the normal traveling region, a preceding vehicle as the movement triggering factor is present ahead of the subject vehicle in the traveling direction, and a brake lamp of the preceding vehicle is lit.

(7) In this case, preferably, the driving support system further includes a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, in which the course changing predictor predicts execution of the course changing in a case where the traveling position is located in the normal traveling region, a preceding vehicle as the movement triggering factor is present ahead of the subject vehicle in the traveling direction, and a turn signal of the preceding vehicle is lit.

(8) In this case, preferably, the alert target recognizer changes a widthwise length of the alert region depending on the traveling position in a case where the normal traveling region is separated into two or more lanes.

(9) In this case, preferably, in a case where the traveling position is located in the road shoulder region or in a case where the traveling position is located at a lane edge of one of the lanes, the alert target recognizer makes the widthwise length of the alert region shorter than in a case where the traveling position is located at a center of one of the lanes.

(10) In this case, preferably, the driving support system further includes a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, in which the course changing predictor predicts that the subject vehicle will not change course from the normal traveling region to the road shoulder region in a case where the subject vehicle travels in the normal traveling region and within a predetermined distance from a line that separates the road shoulder region and the normal traveling region continuously for more than or equal to a predetermined time period.

(11) In this case, preferably, the driving support system further includes a traveling position learner configured to learn a traveling position of the subject vehicle in a road width direction, in which the course changing predictor predicts execution of the course changing based on the surrounding information and a result of learning performed by the traveling position learner.

(12) In this case, preferably, the subject vehicle is a saddle type vehicle.

(1) In the driving support system according to the present invention, the surrounding information acquirer acquires surrounding information related to a state of surroundings of the subject vehicle, the alert target recognizer recognizes another vehicle present in an alert region defined to be laterally behind the subject vehicle as an alert target, and the alert controller performs first alert control of alerting a driver of the subject vehicle about the presence of the alert target. Based on the surrounding information, the course changing predictor predicts execution of course changing by the subject vehicle to be performed while the alert target is recognized. Herein, in a case where the subject vehicle is one that can travel on a road shoulder, such as a motorcycle, the driver of the subject vehicle in some cases enters/exits the road shoulder without activating a turn signal as described above. The present invention addresses this, and the alert controller performs the second alert control with a higher alert intensity than the first alert control in the case where execution of course changing is predicted based on the surrounding information while the first alert control is performed, in other words, while the presence of the alert target is recognized. Therefore, according to the present invention, the alert controller performs the second alert control with a higher alert intensity in a case where the driver of the subject vehicle is going to change course without recognizing the presence of the alert target and without activating a turn signal. This enables the driver of the subject vehicle to recognize the presence of the alert target before actually changing course of the vehicle body, which in turn can improve traffic safety.

(2) In the present invention, the course changing predictor predicts execution of course changing by the subject vehicle based on the surrounding information in the case where it is recognized that a movement triggering factor that triggers a movement of the subject vehicle in the width direction is present ahead of the subject vehicle in the traveling direction. Therefore, according to the present invention, the second alert control can be performed before the vehicle body of the subject vehicle actually starts a course changing motion. This can ensure a sufficient time period for the driver to determine the appropriateness of execution of course changing while seeing a surrounding situation.

(3) In the present invention, the course changing predictor predicts that the subject vehicle will change course from the road shoulder region to the normal traveling region in the case where the traveling position of the subject vehicle is located in the road shoulder region and the obstacle as the movement triggering factor is present ahead of the subject vehicle in the traveling direction. Therefore, according to the present invention, the second alert control can be performed before the vehicle body of the subject vehicle actually starts the course changing motion for avoiding contact with the obstacle present ahead. This can ensure a sufficient time period for the driver to determine the appropriateness of execution of course changing while seeing a surrounding situation.

(4) In the present invention, the course changing predictor predicts that the subject vehicle will change course so as to avoid contact with a preceding vehicle in the case where the traveling position of the subject vehicle is located in the normal traveling region, the preceding vehicle as the movement triggering factor is present ahead of the subject vehicle in the traveling direction, and the risk index for this preceding vehicle is smaller than or equal to the predetermined threshold value. Therefore, according to the present invention, the second alert control can be performed before the vehicle body of the subject vehicle actually starts the course changing motion for avoiding contact with the preceding vehicle. This can ensure a sufficient time period for the driver to determine the appropriateness of execution of course changing while seeing a surrounding situation.

(5) In the present invention, the course changing predictor predicts execution of course changing by the subject vehicle in the case where the traveling position of the subject vehicle is located in the normal traveling region, the preceding vehicle and the traffic light as the movement triggering factors are present ahead of the subject vehicle in the traveling direction, and the display mode of the traffic light represents no-entry or stop. Therefore, according to the present invention, the second alert control can be performed before the vehicle body of the subject vehicle actually starts the course changing motion for avoiding contact with the preceding vehicle which is going to stop. This can ensure a sufficient time period for the driver to determine the appropriateness of execution of course changing while seeing a surrounding situation.

(6) In the present invention, the course changing predictor predicts execution of course changing by the subject vehicle in the case where the traveling position of the subject vehicle is located in the normal traveling region, the preceding vehicle as the movement triggering factor is present ahead of the subject vehicle in the traveling direction, and a brake lamp of the preceding vehicle is lit. Therefore, according to the present invention, the second alert control can be performed before the vehicle body of the subject vehicle actually starts the course changing motion for avoiding contact with the preceding vehicle which is going to stop. This can ensure a sufficient time period for the driver to determine the appropriateness of execution of course changing while seeing a surrounding situation.

(7) In the present invention, the course changing predictor predicts execution of course changing by the subject vehicle in the case where the traveling position of the subject vehicle is located in the normal traveling region, the preceding vehicle as the movement triggering factor is present ahead of the subject vehicle in the traveling direction, and a turn signal of the preceding vehicle is lit. Therefore, according to the present invention, the second alert control can be performed before the vehicle body of the subject vehicle actually starts the course changing motion for avoiding contact with the preceding vehicle which is going to change course. This can ensure a sufficient time period for the driver to determine the appropriateness of execution of course changing while seeing a surrounding situation.

(8) A case where the road on which the subject vehicle is traveling has two lanes on each side, in other words, a case where the road on which the subject vehicle is traveling is separated into a first lane, a second lane, and a road shoulder region from a median strip side by at least two separation lines, is now studied. It is considered that on such a road having two lanes on each side, a likelihood that a vehicle traveling in the road shoulder region or close to the road shoulder region in the second lane changes course to the first lane is lower than a likelihood that a vehicle traveling at the center of the second lane changes course to the first lane. Therefore, if the widthwise length of an alert region is made equal for the vehicle traveling in the road shoulder region or close to the road shoulder region in the second lane and the vehicle traveling at the center of the second lane, a vehicle traveling in the first lane might be recognized as an alert target to bother the driver even though the subject vehicle is traveling in the road shoulder region or close to the road shoulder region in the second lane. Thus, in the present invention, the widthwise length of an alert region is changed depending on the traveling position of the subject vehicle in a case where the normal traveling region is separated into two or more lanes. This can prevent alerting from being frequently executed to bother the driver.

(9) According to the present invention, in the case where the traveling position is located in the road shoulder region or in the case where the traveling position is located at a lane edge of one of the lanes, the alert target recognizer makes the widthwise length of the alert region shorter than in the case where the traveling position is located at the center of one of the lanes. This can prevent alerting from being frequently executed to bother the driver.

(10) In the present invention, the course changing predictor determines that the driver of the subject vehicle has no intention to enter the road shoulder region and predicts that the subject vehicle will not change course from the normal traveling region to the road shoulder region in the case where the subject vehicle travels in the normal traveling region and within the predetermined distance from the line that separates the road shoulder region and the normal traveling region continuously for more than or equal to the predetermined time period. Therefore, the present invention can prevent the second alert control from being frequently performed for the driver having no intention to travel in the road shoulder region to bother the driver.

(11) In the present invention, the traveling position learner learns the traveling position of the subject vehicle in the road width direction, and the course changing predictor predicts execution of course changing based on the surrounding information and a result of learning performed by the traveling position learner. Therefore, according to the present invention, execution of course changing can be predicted in consideration of a tendency of traveling positions in the past, so that timing for executing the second alert control can be made suitable for the driver.

(12) A saddle type vehicle such as a motorcycle or a buggy is smaller in vehicle width and lighter in weight than a four-wheeled vehicle and thus in some cases enters/exits a road shoulder without activating a turn signal. Therefore, according to the present invention, traffic safety can be improved by performing the first and second alert controls for such a saddle type vehicle through the procedure as described above.

### BRIEF DESCRIPTION OF THE DRAWINGS

FIG. 1 is a view illustrating a configuration of a driving support system according to an embodiment of the present invention;

FIG. 2A is a view illustrating a display example of an alarm image in a case where another vehicle reflected on a mirror surface of a right side mirror is determined as an alert target;

FIG. 2B is a view schematically illustrating a case where the alarm image illustrated in FIG. 2A is flashed;

FIG. 3 is a view illustrating an example of a travelable range specified by a traveling position specification unit;

FIG. 4A is a view schematically illustrating a configuration of a right alert region and a left alert region zoned in a case where a subject vehicle travels near the center of a second lane on a road having two lanes on each side;

FIG. 4B is a view schematically illustrating a configuration of a right alert region and a left alert region zoned in a case where the subject vehicle travels close to a second separation line in the second lane on the road having two lanes on each side;

FIG. 4C is a view schematically illustrating a configuration of a right alert region and a left alert region zoned in a case where the subject vehicle travels close to a first separation line in the second lane on the road having two lanes on each side;

FIG. 5A is a view schematically illustrating a configuration of a right alert region and a left alert region zoned in a case where the subject vehicle travels near the center of a second lane on a road having three lanes on each side;

FIG. 5B is a view schematically illustrating a configuration of a right alert region and a left alert region zoned in a case where the subject vehicle travels close to a second separation line in the second lane on the road having three lanes on each side;

FIG. 5C is a view schematically illustrating a configuration of a right alert region and a left alert region zoned in a case where the subject vehicle travels close to a first separation line in the second lane on the road having three lanes on each side;

FIG. 6A is a view illustrating a first example of a movement triggering factor;

FIG. 6B is a view illustrating a second example of the movement triggering factor;

FIG. 6C is a view illustrating a third example of the movement triggering factor;

FIG. 6D is a view illustrating a fourth example of the movement triggering factor;

FIG. 6E is a view illustrating a fifth example of the movement triggering factor;

FIG. 6F is a view illustrating a sixth example of the movement triggering factor;

FIG. 7A is a flowchart illustrating a specific procedure of alert processing (Part I);

FIG. 7B is a flowchart illustrating the specific procedure of the alert processing (Part II); and

FIG. 8 is a view illustrating a state in which a subject vehicle traveling on the road having two lanes on each side is going to overtake a preceding vehicle.

### DETAILED DESCRIPTION OF THE INVENTION

Hereinafter, a driving support system according to an embodiment of the present invention will be described with reference to the drawings.

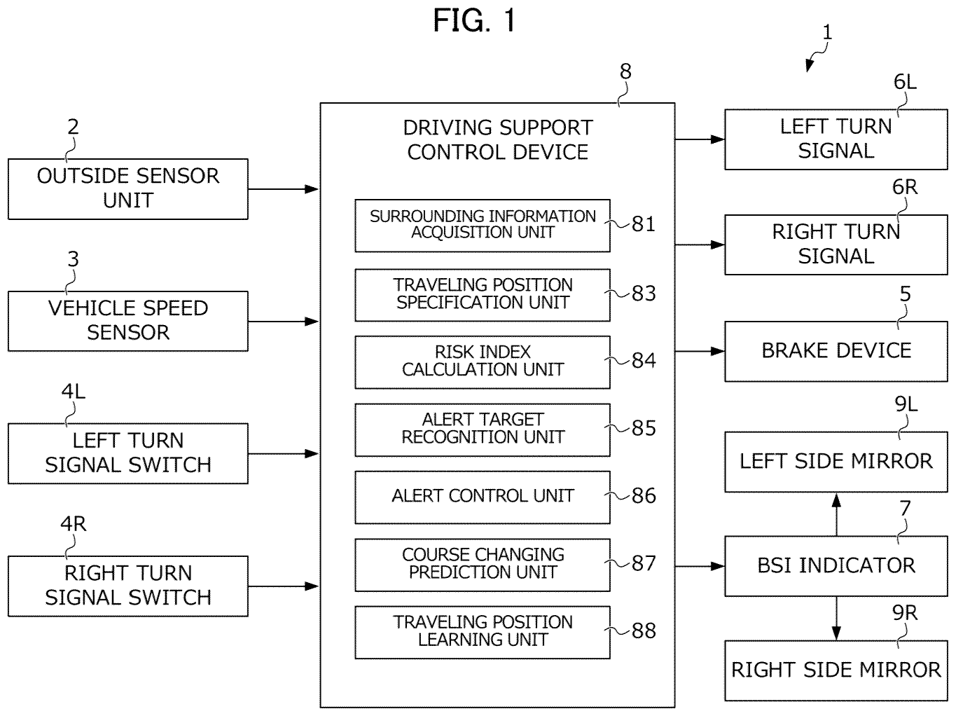

FIG. 1 is a view illustrating a configuration of a driving support system 1 according to the present embodiment. This driving support system 1 is mounted on a vehicle not illustrated. Note that a case where the driving support system 1 is mounted on a saddle type vehicle smaller in vehicle width and lighter in weight than a four-wheeled vehicle, more specifically, a motorcycle, will be described below, but the present invention is not limited to this. The driving support system 1 may be mounted on a four-wheeled vehicle in addition to saddle type vehicles such as a saddle type three-wheeled vehicle, a saddle type four-wheeled vehicle, and a motorized bicycle. Note that a drive source of a motorcycle may be an internal-combustion engine, a rotating electrical machine, or a combination thereof. Moreover, a power source of the rotating electrical machine may be a secondary battery, a capacitor, or a fuel cell.

The driving support system 1 supports safe driving of a motorcycle by a rider. Hereinafter, what is called a BSI function of alerting a rider about the presence of another vehicle approaching from laterally behind, which is a blind spot for the rider, among various driving support functions implemented by this driving support system 1 will be described.

The driving support system 1 includes an outside sensor unit 2, a vehicle speed sensor 3, turn signal switches 4L, 4R, a brake device 5, turn signals 6L, 6R, a BSI indicator 7, a driving support control device 8, and side mirrors 9L, 9R.

The outside sensor unit 2 includes a plurality of in-vehicle sensors that acquire information related to a surrounding situation of the subject vehicle, such as a forward camera unit and rearward radar units.

The forward camera unit includes, for example, a digital camera utilizing a solid state image sensor such as a charge coupled device (CCD) and a complementary metal oxide semiconductor (CMOS). This forward camera unit can be attached to any position (such as a front windshield or a mirror, for example) on a front portion of a vehicle body in a state where the forward camera unit faces a forward side of the subject vehicle in a traveling direction. The rearward radar units include a millimeter-wave radar that detects a target by measuring a reflected wave of radiation of a millimeter wave from the target. The rearward radar units can be provided at any positions (for example, near a tail lamp and near turn signals on both the right and left sides) of a rear portion of the vehicle body in a state where the rearward radar units face a rearward side of the subject vehicle in the traveling direction and detects an object present laterally behind the vehicle body (rearward to the right and rearward to the left). Data obtained by the forward camera unit, the rearward radar units, and the like is transmitted to the driving support control device 8.

The vehicle speed sensor 3 detects a moving speed (hereinafter referred to as a “vehicle speed”) of the vehicle body in the traveling direction and transmits a signal in accordance with a vehicle speed detected value to the driving support control device 8. For example, a rotary encoder that outputs a signal in accordance with a rotation speed of a rear wheel not illustrated is used as the vehicle speed sensor 3.

The left turn signal switch 4L and the right turn signal switch 4R are operation components that can be operated by the rider for informing traffic participants in the surroundings (hereinafter also referred to as “surrounding traffic participants”) such as an oncoming vehicle and a following vehicle about the traveling direction of the vehicle body and are provided, for example, at a base of a left handle grip to be gripped by the rider with his/her left hand. When the left turn signal switch 4L is turned on by the rider, a turn signal driving circuit not illustrated activates (in other words, flashes) the left turn signal 6L provided on the left side of the vehicle body as seen from the rider. When the right turn signal switch 4R is turned on by the rider, the turn signal driving circuit activates (flashes) the right turn signal 6R provided on the right side of the vehicle body as seen from the rider.

The brake device 5 includes, for example, a brake caliper, a cylinder that transfers a hydraulic pressure to the brake caliper in accordance with an operation amount of a brake lever or a brake pedal, an electric motor that generates a hydraulic pressure in the cylinder, an electronic control unit that controls the electric motor based on a command signal transmitted from the driving support control device 8 and generates braking force in accordance with a command, and the like.

The BSI indicator 7 displays an alarm image related to another vehicle present rearward on the left side or rearward on the right side which is a blind spot as seen from the rider during driving on a display screen provided at a position that is visible to the rider, thereby supporting the rider for recognition of the presence of the other surrounding vehicle. Note that hereinafter, a case where the BSI indicator 7 displays an alarm image on the left side mirror 9L or the right side mirror 9R that is easily visible to the rider during driving will be described, but the present invention is not limited to this. The BSI indicator 7 may display an alarm image on, for example, a shield of a helmet worn by the rider in a manner that is visible to the rider during driving.

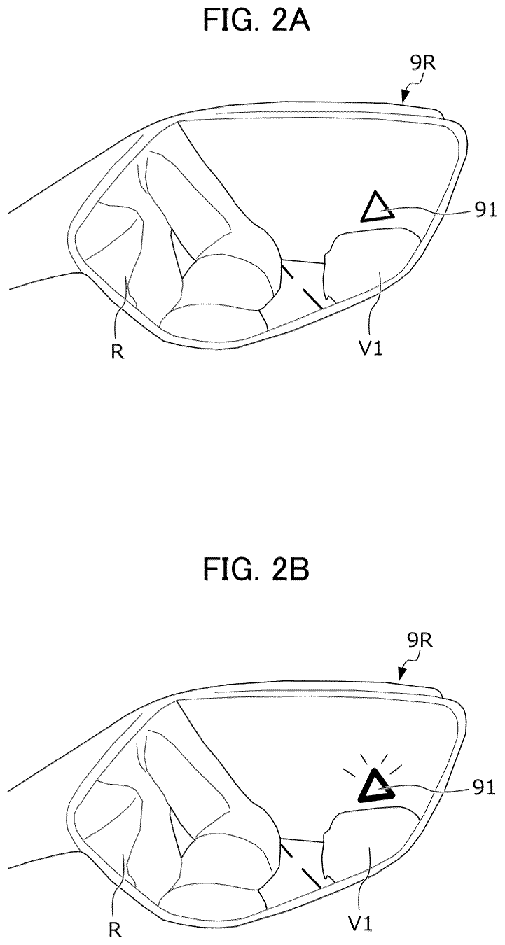

FIG. 2A is a view illustrating a display example of an alarm image 91 in a case where a following vehicle V1 reflected on a mirror surface of the right side mirror 9R is an alert target. FIG. 2A illustrates a case where the BSI indicator 7 always lights a triangular image at a predetermined brightness near the alert target reflected on the mirror surface as the alarm image 91 for causing the rider to recognize the presence of the following vehicle V1 as the alert target reflected on the mirror surface of the right side mirror 9R, but the shape of the alarm image 91 is not limited to this. The alarm image 91 may have any shape that can suggest the presence of the alert target to the rider.

FIG. 2B is a view schematically illustrating a case where the alarm image 91 illustrated in FIG. 2A is flashed. The BSI indicator 7 flashes the always-lit alarm image 91 to more strongly suggest the presence of the alert target to the rider. In other words, the BSI indicator 7 flashes the always-lit alarm image 91 to raise an alert intensity.

Referring back to FIG. 1, the driving support control device 8 is a computer that exerts control regarding a driving support function. The driving support control device 8 includes a surrounding information acquisition unit 81, a traveling position specification unit 83, a risk index calculation unit 84, an alert target recognition unit 85, an alert control unit 86, a course changing prediction unit 87, and a traveling position learning unit 88 as modules that implement the BSI function among a plurality of driving support functions.

The surrounding information acquisition unit 81 subjects a detection result obtained by the outside sensor unit 2 to sensor fusion processing to acquire surrounding information related to a state of surroundings of the subject vehicle, more specifically, information about positions, shapes, types, and speed of a road and an object present ahead of the subject vehicle, content of a road traffic sign, and the like as well as information related to an object present behind the subject vehicle. The surrounding information acquisition unit 81 transmits the acquired surrounding information to, for example, the traveling position specification unit 83, the risk index calculation unit 84, the alert target recognition unit 85, the course changing prediction unit 87, the traveling position learning unit 88, and the like.

The traveling position specification unit 83 specifies a position in a road width direction on the road on which the subject vehicle travels based on the surrounding information transmitted from the surrounding information acquisition unit 81. More specifically, based on the surrounding information acquired by the surrounding information acquisition unit 81, the traveling position specification unit 83 specifies a road range in which the subject vehicle can travel as a travelable range and specifies a traveling position of the subject vehicle in the width direction in this travelable range. The traveling position specification unit 83 transmits information about the specified traveling position to the risk index calculation unit 84, the alert target recognition unit 85, the course changing prediction unit 87, the traveling position learning unit 88, and the like.

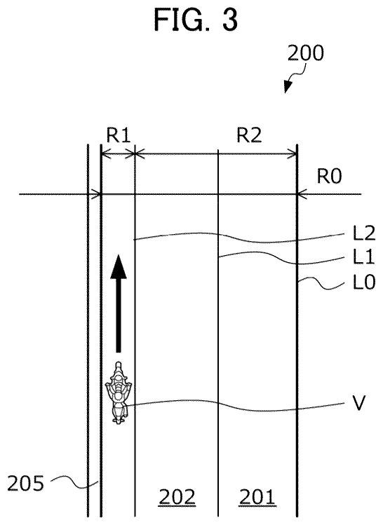

FIG. 3 is a view illustrating an example of a travelable range R0 specified by the traveling position specification unit 83. FIG. 3 illustrates an example of a road 200 having two lanes on each side in a district where left-side driving is prescribed. In the example illustrated in FIG. 3, a first lane 201 is defined between a median strip L0 and a first separation line L1, and a second lane 202 is defined between the first separation line L1 and a second separation line L2. In the example illustrated in FIG. 3, the subject vehicle V can physically travel between the second separation line L2 and a curbstone 205 in addition to the two lanes 201 and 202 defined between the median strip L0 and the second separation line L2. Thus, the traveling position specification unit 83 specifies the road range between the median strip 201 and the curbstone 205 as the travelable range R0. The traveling position specification unit 83 also separates the specified travelable range R0 into a road shoulder region R1 within a predetermined road shoulder width between a widthwise edge (the curbstone 205 in the example of FIG. 3) of the travelable range R0 and the second separation line L2 and a normal traveling region R2 adjacent to this road shoulder region R1. FIG. 3 illustrates a case where the subject vehicle V which is a motorcycle is traveling in the road shoulder region R1.

Referring back to FIG. 1, the risk index calculation unit 84 calculates, for each another vehicle present in the surroundings of the subject vehicle, a risk index which decreases as a risk that the subject vehicle will come into contact with each another vehicle based on the vehicle speed of the subject vehicle acquired by the vehicle speed sensor 3 and the surrounding information acquired by the surrounding information acquisition unit 81. Note that in the present embodiment, a case where the risk index calculation unit 84 uses, as the risk index, what is called Time to Collision (TTC) obtained by dividing an inter-vehicle distance between the subject vehicle and a target another vehicle by a relative speed of the subject vehicle with respect to the target another vehicle will be described, but the present invention is not limited to this. The risk index calculation unit 84 transmits information related to the calculated risk index for each another vehicle in the surroundings to the course changing prediction unit 87.

The alert target recognition unit 85 zones imaginary alert regions rearward on both the right and left sides of the subject vehicle which are blind spots for the rider and recognizes another vehicle present in at least either of these right and left alert regions and satisfying a predetermined alert condition (for example, a condition that the risk index for another vehicle present in an alert region is smaller than or equal to a predetermined threshold value) as an alert target. In a case where another vehicle in an alert region is recognized by the alert target recognition unit 85 as an alert target, the alert control unit 86 executes first alert control and second alert control following a procedure which will be described later to cause the rider to recognize the presence of this alert target.

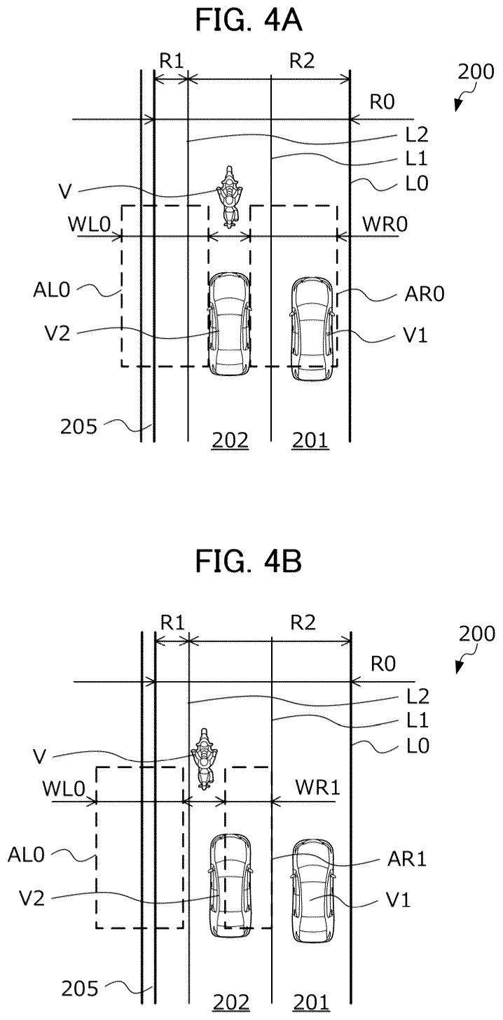

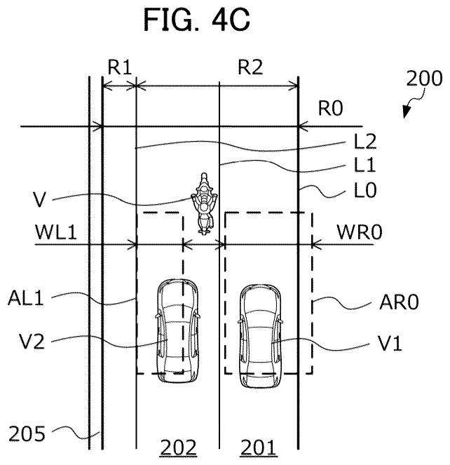

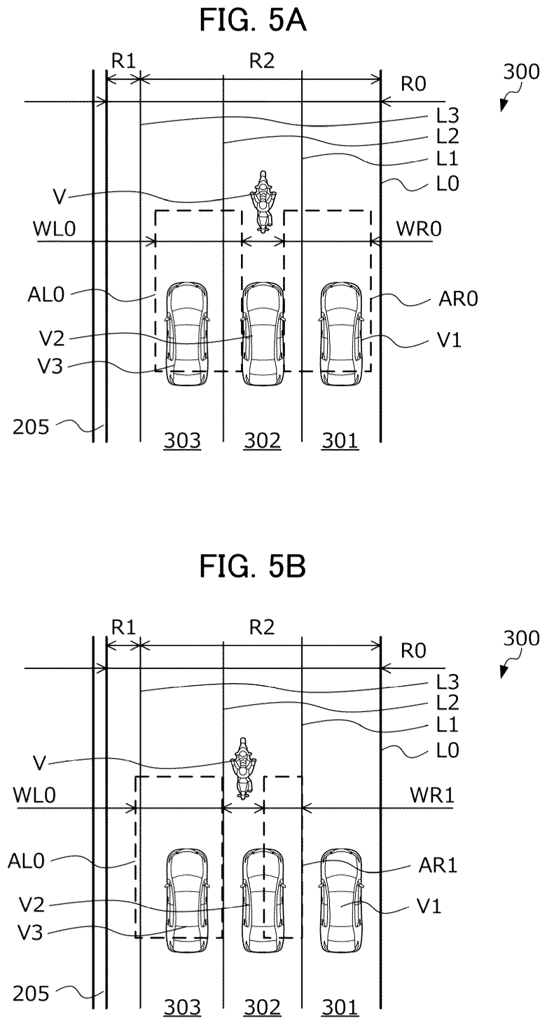

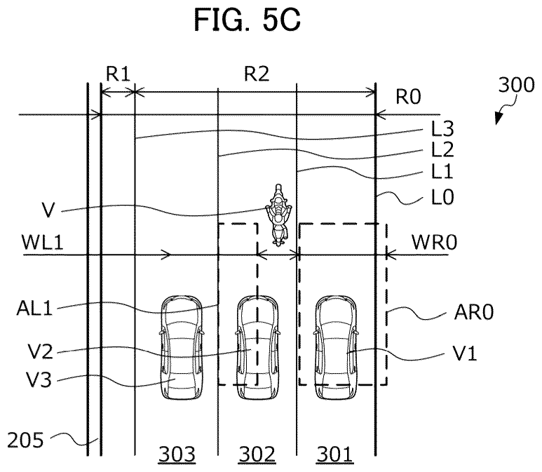

A procedure of zoning imaginary alert regions by the alert target recognition unit 85 will now be described with reference to FIG. 4A to FIG. 4C (an example of two lanes on each side) and FIG. 5A to FIG. 5C (an example of three lanes on each side). As will be described below, the alert target recognition unit 85 changes a widthwise length of an alert region depending on the traveling position.

FIG. 4A is a view schematically illustrating a configuration of a right alert region AR0 and a left alert region AL0 imaginarily zoned by the alert target recognition unit 85 of the subject vehicle V traveling near the center of the second lane 202 on the road 200 having two lanes on each side.

As illustrated in FIG. 4A, in the case where the traveling position of the subject vehicle V is located near the center of the second lane 202, the alert target recognition unit 85 zones the rectangular right alert region AR0 rearward on the right side as seen from the rider of the subject vehicle V and zones the rectangular left alert region AL0 rearward on the left side. Note that a case where the respective alert regions AR0 and AL0 have equal lengths in the vehicle width direction and in the traveling direction, respectively, on the right and left will be described in the present embodiment, but the present invention is not limited to this. The lengths of respective sides of these alert regions AR0 and AL0 may have a difference between the right and left depending on a traffic situation in a target district. Note that hereinafter, in a case where the traveling position of the subject vehicle V is located near the center of one of the lanes 201 and 202 as illustrated in FIG. 4A, lengths in the vehicle width direction of both the alert regions AR0 and AL0 zoned by the alert target recognition unit 85 are denoted as WR0 and WL0. Hereinafter, the lengths WR0 and WL0 in the vehicle width direction of both the alert regions AR0 and AL0 zoned by the alert target recognition unit 85 in the case where the traveling position of the subject vehicle V is located near the center of one of the lanes 201 and 202 will also be called basic lengths.

Note that in the example illustrated in FIG. 4A, the following vehicle V1 may be an alert target because of traveling in the right alert region AR0, but a following vehicle V2 could not be an alert target because of traveling outside both the alert regions AR0 and AL0.

A right alert region and a left alert region zoned by the alert target recognition unit 85 in the case where the traveling position of the subject vehicle V is located near the center of the first lane 201 are qualitatively the same as those in the example illustrated in FIG. 4A, and depiction and detailed description thereof will thus be omitted.

FIG. 4B is a view schematically illustrating a configuration of a right alert region AR1 and the left alert region AL0 imaginarily zoned by the alert target recognition unit 85 of the subject vehicle V traveling near a lane edge close to the second separation line L2 in the second lane 202 of the road 200 having two lanes on each side which is the same as that in FIG. 4A. In other words, the example illustrated in FIG. 4B is different from the example illustrated in FIG. 4A in the traveling position of the subject vehicle V in the second lane 202.

As illustrated in FIG. 4B, the alert target recognition unit 85 zones the rectangular right alert region AR1 rearward on the right side as seen from the rider of the subject vehicle V and zones the rectangular left alert region AL0 rearward on the left side similarly to the example illustrated in FIG. 4A. As illustrated in FIG. 4B, in a case where the subject vehicle V is traveling near a lane edge on the left side in the second lane 202 as seen from the rider, it is considered that the rider is less likely to intend to move to the first lane 201 side on the right side as seen from the rider than in the case illustrated in FIG. 4A. Thus, the alert target recognition unit 85 makes the length WR1 in the vehicle width direction of the right alert region AR1 on the first lane 201 side to which it is considered that the rider is less likely to intend to move as seen from the rider shorter than the basic length WR0 illustrated in FIG. 4A. More specifically, the alert target recognition unit 85 makes the length WR1 in the vehicle width direction of the right alert region AR1 shorter than the basic length WR0 such that a right edge line of the right alert region AR1 is aligned with the first separation line L1 that separates the first lane 201 and the second lane 202.

Accordingly, in the example illustrated in FIG. 4B, the following vehicle V2 traveling in the same lane as the subject vehicle V may be an alert target because of traveling in the right alert region AR1, but the following vehicle V1 traveling in the first lane 201 to which it is considered that the rider of the subject vehicle V is less likely to intend to move could not be an alert target because of traveling outside both the alert regions AR1 and AL0.

Note that in the case where the subject vehicle V travels in the road shoulder region R1 adjacent to the second lane 202, it is considered that the rider is less likely to intend to move to the first lane 201 side crossing over the second lane 202 similarly to the example illustrated in FIG. 4B. Therefore, the respective alert regions zoned by the alert target recognition unit 85 in the case where the subject vehicle V travels in the road shoulder region R1 are qualitatively the same as those in FIG. 4B, and depiction and detailed description thereof will thus be omitted.

FIG. 4C is a view schematically illustrating a configuration of the right alert region AR0 and a left alert region AL1 imaginarily zoned by the alert target recognition unit 85 of the subject vehicle V traveling near a lane edge close to the first separation line L1 in the second lane 202 of the road 200 having two lanes on each side which is the same as that of FIG. 4A and FIG. 4B. In other words, the example illustrated in FIG. 4C is different from the examples illustrated in FIG. 4A and FIG. 4B in the traveling position of the subject vehicle V in the second lane 202.

As illustrated in FIG. 4C, the alert target recognition unit 85 zones the rectangular right alert region AR0 rearward on the right side as seen from the rider of the subject vehicle V and zones the rectangular left alert region AL1 rearward on the left side similarly to the example illustrated in FIG. 4A. In the case where the subject vehicle V is traveling near the lane edge on the right side as seen from the rider in the second lane 202 as illustrated in FIG. 4C, it is considered that the rider is less likely to intend to move to the road shoulder region R1 on the left side as seen from the rider than in the case illustrated in FIG. 4A. Thus, the alert target recognition unit 85 makes the length WL1 in the vehicle width direction of the left alert region AL1 on the road shoulder region R1 side to which it is considered that the rider is less likely to intend to move as seen from the rider shorter than the basic length WL0 illustrated in FIG. 4A. More specifically, the alert target recognition unit 85 makes the length WL1 in the vehicle width direction of the left alert region AL1 shorter than the basic length WL0 such that a left edge line of the left alert region AL1 is aligned with the second separation line L2 that separates the second lane 202 and the road shoulder region R1.

Accordingly, in the example illustrated in FIG. 4C, the following vehicle V2 traveling in the same lane as the subject vehicle V and the following vehicle V1 traveling in the first lane 201 may both be alert targets because of traveling in the left alert region AL1 and the right alert region AR1, respectively.

FIG. 5A is a view schematically illustrating a configuration of the right alert region AR0 and the left alert region AL0 imaginarily zoned by the alert target recognition unit 85 of the subject vehicle V traveling near the center of a second lane 302 which is a center lane on a road 300 having three lanes on each side.

As illustrated in FIG. 5A, in the case where the traveling position of the subject vehicle V is located near the center of the second lane 302, the alert target recognition unit 85 zones the alert regions AR0 and AL0 in the same ranges as those in the example illustrated in FIG. 4A.

Note that in the example illustrated in FIG. 5A, the following vehicle V1 traveling in a first lane 301 and a following vehicle V3 traveling in a third lane 303 may be alert targets because of traveling in the alert regions AR0 and AL0, respectively, but the following vehicle V2 traveling in the same lane could not be an alert target because of traveling outside both the alert regions AR0 and AL0.

The right alert region and the left alert region zoned by the alert target recognition unit 85 in a case where the traveling position of the subject vehicle V is located near the center of the first lane 301 or near the center of the third lane 303 are qualitatively the same as those in the example illustrated in FIG. 5A, and depiction and detailed description thereof will thus be omitted.

FIG. 5B is a view schematically illustrating a configuration of the right alert region AR1 and the left alert region AL0 imaginarily zoned by the alert target recognition unit 85 of the subject vehicle V traveling near a lane edge close to the second separation line L2 in the second lane 302 of the road 300 having three lanes on each side which is the same as that in FIG. 5A. In other words, the example illustrated in FIG. 5B is different from the example illustrated in FIG. 5A in the traveling position of the subject vehicle V in the second lane 302.

As illustrated in FIG. 5B, the alert target recognition unit 85 zones the rectangular right alert region AR1 rearward on the right side as seen from the rider of the subject vehicle V and zones the rectangular left alert region AL0 rearward on the left side similarly to the example illustrated in FIG. 5A. As illustrated in FIG. 5B, in a case where the subject vehicle V is traveling near the lane edge on the left side in the second lane 302 as seen from the rider, it is considered that the rider is less likely to intend to move to the first lane 301 side on the right side as seen from the rider than in the case illustrated in FIG. 5A. Thus, the alert target recognition unit 85 makes the length WR1 in the vehicle width direction of the right alert region AR1 on the first lane 301 side to which it is considered that the rider is less likely to intend to move as seen from the rider shorter than the basic length WR0 illustrated in FIG. 5A. More specifically, the alert target recognition unit 85 makes the length WR1 in the vehicle width direction of the right alert region AR1 shorter than the basic length WR0 such that the right edge line of the right alert region AR1 is aligned with the first separation line L1 that separates the first lane 301 and the second lane 302.

Accordingly, in the example illustrated in FIG. 5B, the following vehicle V2 traveling in the same lane as the subject vehicle V and the following vehicle V3 traveling in the third lane 303 may be alert targets because of traveling in the alert regions AR1 and AL0, respectively, but the following vehicle V1 traveling in the first lane 301 to which it is considered that the rider of the subject vehicle V is less likely to intend to move could not be an alert target because of traveling outside both the alert regions AR1 and AL0.

Note that in a case where the subject vehicle V is traveling near a lane edge close to a third separation line L3 in the third lane 303 or in a case where the subject vehicle V travels in the road shoulder region R1 adjacent to the third lane 303, it is considered that the rider is less likely to intend to move to the second lane 302 side on the right side similarly to the example illustrated in FIG. 5B. Therefore, the respective alert regions zoned by the alert target recognition unit 85 in the case where the subject vehicle V is traveling near the lane edge close to the third separation line L3 in the third lane 303 and in the case where the subject vehicle V travels in the road shoulder region R1 are qualitatively the same as those in FIG. 5B, and depiction and detailed description thereof will thus be omitted.

FIG. 5C is a view schematically illustrating a configuration of the right alert region AR0 and the left alert region AL1 imaginarily zoned by the alert target recognition unit 85 of the subject vehicle V traveling near a lane edge close to the first separation line L1 in the second lane 302 of the road 300 having three lanes on each side which is the same as that in FIG. 5A and FIG. 5B. In other words, the example illustrated in FIG. 5C is different from the examples illustrated in FIG. 5A and FIG. 5B in the traveling position of the subject vehicle V in the second lane 302.

As illustrated in FIG. 5C, the alert target recognition unit 85 zones the rectangular right alert region AR0 rearward on the right side as seen from the rider of the subject vehicle V and zones the rectangular left alert region AL1 rearward on the left side, similarly to the example illustrated in FIG. 5A. As illustrated in FIG. 5C, in a case where the subject vehicle V is traveling near a lane edge on the right side as seen from the rider in the second lane 302, it is considered that the rider is less likely to intend to move to the third lane 303 on the left side as seen from the rider than in the case illustrated in FIG. 5A. Thus, the alert target recognition unit 85 makes the length WL1 in the vehicle width direction of the left alert region AL1 on the third lane 303 side to which it is considered that the rider is less likely to intend to move as seen from the rider shorter than the basic length WL0 illustrated in FIG. 5A. More specifically, the alert target recognition unit 85 makes the length WL1 in the vehicle width direction of the left alert region AL1 shorter than the basic length WL0 such that the left edge line of the left alert region AL1 is aligned with the second separation line L2 that separates the second lane 302 and the third lane 303.

Accordingly, in the example illustrated in FIG. 5C, the following vehicle V2 traveling in the same lane as the subject vehicle V and the following vehicle V1 traveling in the first lane 301 may be alert targets because of traveling in the alert regions AR0 and AL1, respectively, but the following vehicle V3 traveling in the third lane 303 to which it is considered that the rider of the subject vehicle V is less likely to intend to move could not be an alert target because of traveling outside both the alert regions AR0 and AL1.

Note that in a case where the subject vehicle V travels near the lane edge close to the second separation line L2 in the third lane 303, it is considered that the rider is less likely to intend to move to the road shoulder region R1 side adjacent to the third lane 303 similarly to the example illustrated in FIG. 5C. Therefore, the alert regions zoned by the alert target recognition unit 85 in the case where the subject vehicle V travels near the lane edge close to the second separation line L2 in the third lane 303 are qualitatively the same as those in FIG. 5C, and depiction and detailed description thereof will thus be omitted.

As described above, in the case where the normal traveling region R2 is separated into two or more lanes, the alert target recognition unit 85 changes the lengths in the vehicle width direction of the right and left alert regions depending on the traveling position of the subject vehicle V. More specifically, in the case where the traveling position is located in the road shoulder region R1, the alert target recognition unit 85 makes the length in the vehicle width direction of an alert region on the normal traveling region R2 side shorter than in the case where the traveling position is located near the center of a lane. In the case where the traveling position is located near the lane edge of a lane (in other words, near a separation line that separates the respective lanes), the alert target recognition unit 85 makes the length in the vehicle width direction of an alert region, which is farther from the separation line, shorter than in the case where the traveling position is located near the center of a lane.

Referring back to FIG. 1, in the case where an alert target is recognized by the alert target recognition unit 85 described above, the alert control unit 86 executes alert control of alerting the rider of the subject vehicle about the presence of this alert target by operating the BSI indicator 7, the brake device 5, or the like, for example. Herein, the alert control unit 86 is capable of executing two types of alert control of alerting the rider about the presence of an alert target, that is, first alert control and second alert control in which an alert intensity for the rider is set higher than in the first alert control so as to cause the rider to recognize the presence of the alert target more strongly than in the first alert control.

In the present embodiment, a case where the alert control unit 86 always lights the alarm image 91 (see FIG. 2A) for suggesting the presence of the alert target with the BSI indicator 7 as the first alert control and flashes the alarm image 91 (see FIG. 2B) for strongly suggesting the presence of the alert target with the BSI indicator 7 as the second alert control will be described, but the present invention is not limited to this. As the second alert control, the alert control unit 86 may emit an alarm sound with the BSI indicator 7, produce a brake pulse with the brake device 5, or vibrate a seat on which the rider is seated with a vibration device not illustrated, in addition to flashing the alarm image 91.

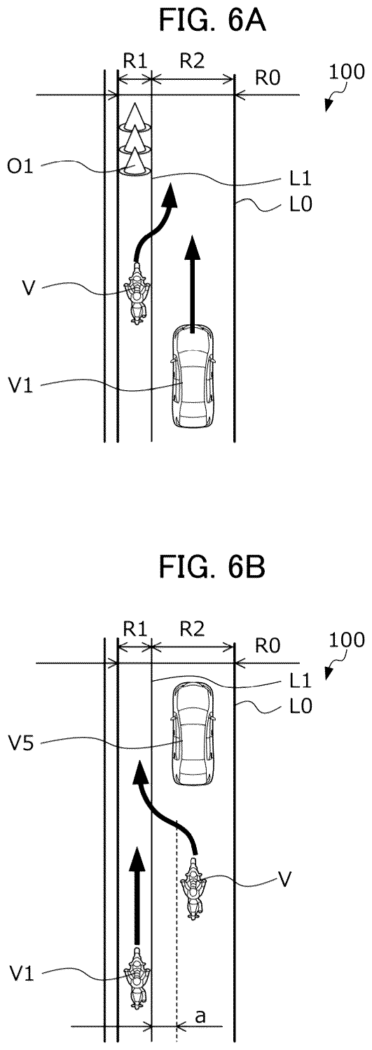

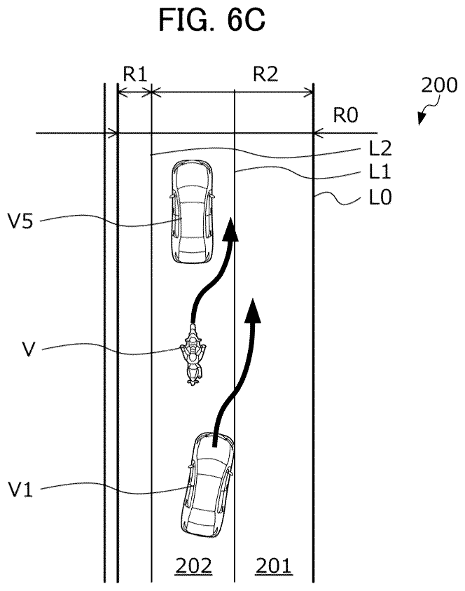

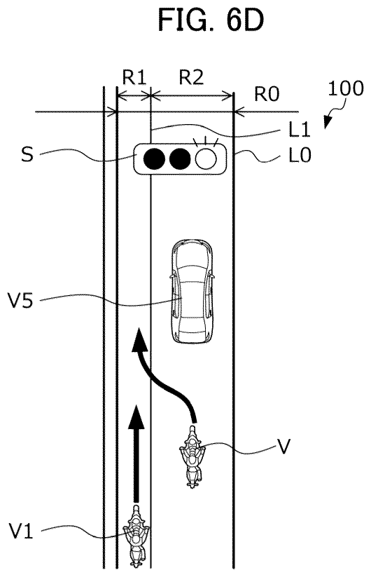

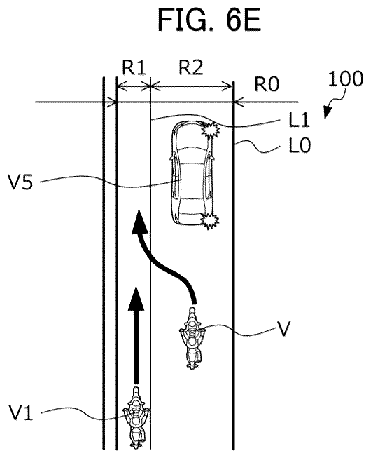

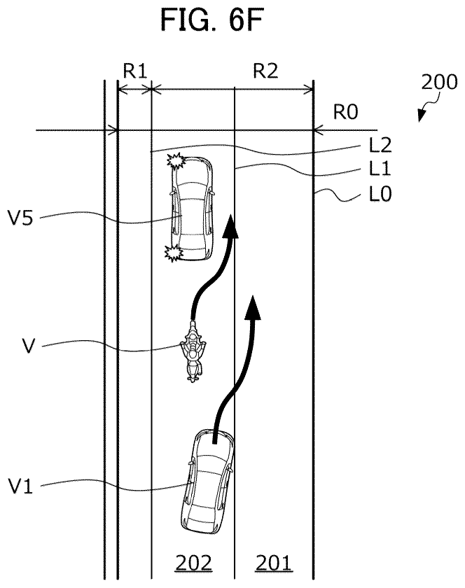

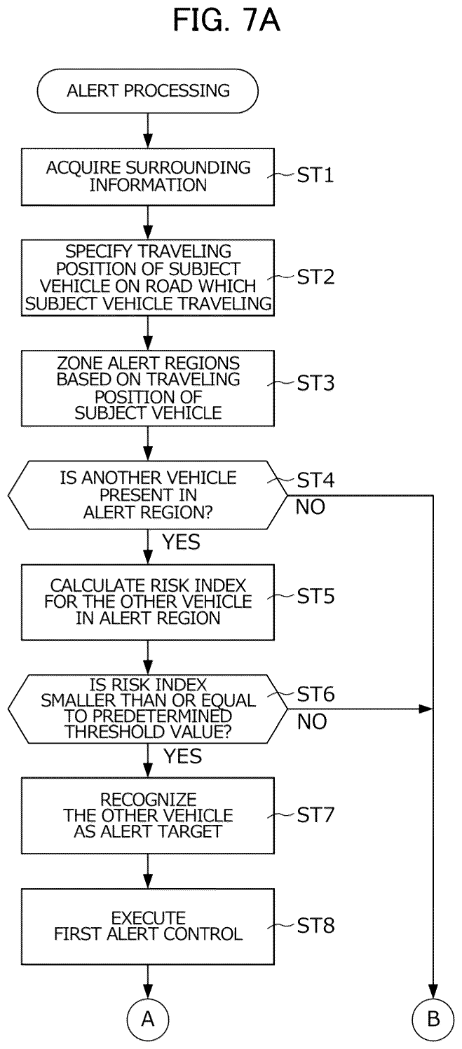

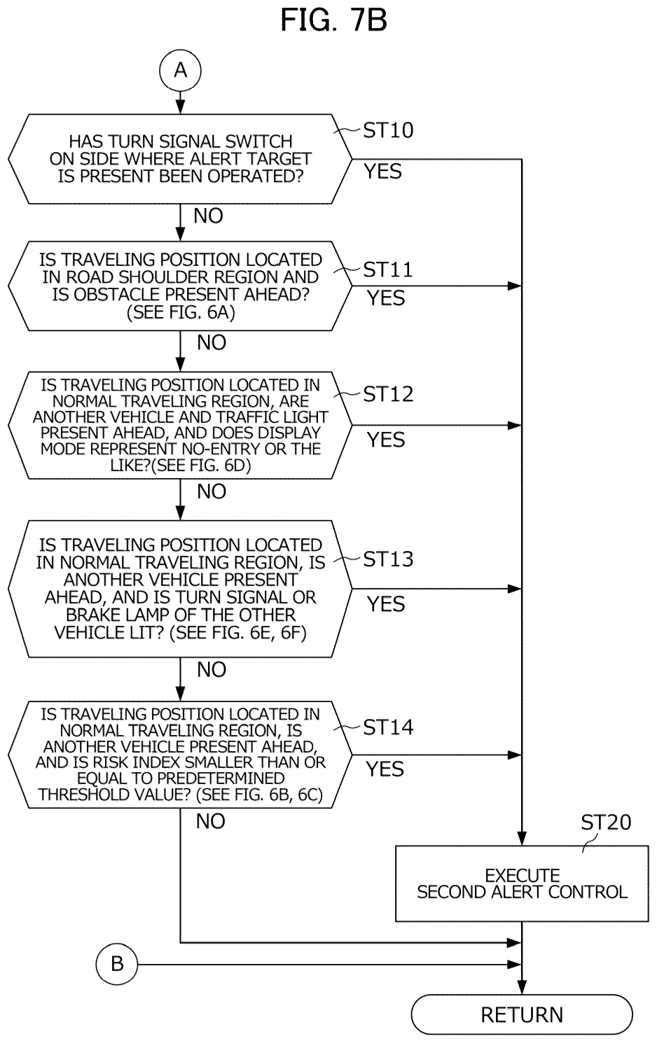

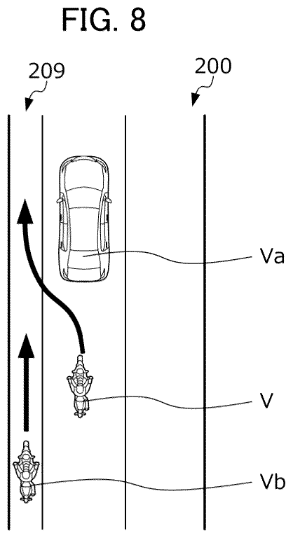

The alert control unit 86 executes the first alert control with a relatively low alert intensity in a case where a new alert target is recognized for the first time by the alert target recognition unit 85 to alert the rider about the presence of the alert target. The alert control unit 86 continuously executes the first alert control while the alert target is recognized by the alert target recognition unit 85. Thereafter, in a case where execution of course changing of the subject vehicle in the vehicle width direction is predicted by the course changing prediction unit 87 which will be described later while the first alert control is performed (see FIG. 6A to FIG. 6F which will be described later), the alert control unit 86 executes the second alert control with a higher alert intensity than the first alert control so as to avoid contact between the subject vehicle which is going to change course and the alert target present in a blind spot to strongly alert the rider about the presence of the alert target. In a case where the turn signal switch 4L or 4R on the side where the alert target is present is operated by the rider while the first alert control is performed, the alert control unit 86 executes the second alert control so as to avoid contact between the subject vehicle which is going to change course and the alert target present in a blind spot to strongly alert the rider about the presence of the alert target (see step ST10 in FIG. 7B which will be described later).

Based on the surrounding information transmitted from the surrounding information acquisition unit 81 and the traveling position information transmitted from the traveling position specification unit 83, the course changing prediction unit 87 predicts execution of course changing in the vehicle width direction by the subject vehicle to be performed while at least one alert target is recognized by the alert target recognition unit 85, and transmits a result of the prediction to the alert control unit 86. More specifically, the course changing prediction unit 87 predicts execution of course changing by the subject vehicle based on the surrounding information in a case where it is recognized that a movement triggering factor that triggers course changing of the subject vehicle in the width direction is present ahead of the subject vehicle in the traveling direction. In the case where execution of course changing is predicted by the course changing prediction unit 87, the alert control unit 86 executes the second alert control with a relatively higher alert intensity as described above so as to strongly suggest the presence of the alert target to the rider as described above. Hereinafter, specific examples of the movement triggering factor that triggers course changing of the subject vehicle as described will be described with reference to FIG. 6A to FIG. 6F.

FIG. 6A is a view illustrating a first example of the movement triggering factor. FIG. 6A illustrates a case where the subject vehicle V is traveling in the road shoulder region R1 and the following vehicle V1 is traveling in a right alert region rearward on the right side on a road 100 having one lane on each side. The example of FIG. 6A also illustrates a case where the alert target recognition unit 85 of the subject vehicle V has recognized this following vehicle V1 as an alert target and the alert control unit 86 executes the first alert control in order to alert the rider of the subject vehicle V about the presence of this alert target.

In a situation as illustrated in FIG. 6A, an obstacle O1 provided ahead of the subject vehicle V in the traveling direction and on the road shoulder region R1 becomes the movement triggering factor that triggers course changing of the subject vehicle V traveling in the road shoulder region R1 to the normal traveling region R2 side. In the situation illustrated in FIG. 6A, the subject vehicle V and the following vehicle V1 might come into contact with each other when the subject vehicle V changes course to the normal traveling region R2 side in order to avoid contact with the obstacle O1.

Thus, the course changing prediction unit 87 predicts that the subject vehicle V will change course from the road shoulder region R1 to the normal traveling region R2 in a case where it is recognized that the traveling position of the subject vehicle V is located in the road shoulder region R1 and the obstacle O1 as the movement triggering factor is present ahead of the subject vehicle V in the traveling direction while at least one alert target is recognized. In response to prediction of execution of course changing by the course changing prediction unit 87 while the first alert control for the following vehicle V1 is executed, the alert control unit 86 can execute the second alert control with a higher alert intensity to strongly cause the rider of the subject vehicle V to recognize the presence of the following vehicle V1 before starting course changing. This can avoid contact between the subject vehicle V and the following vehicle V1.

FIG. 6B is a view illustrating a second example of the movement triggering factor. FIG. 6B illustrates a case where the subject vehicle V is traveling in the normal traveling region R2, the following vehicle V1 is traveling in a left alert region rearward on the left side, and further, a preceding vehicle V5 is traveling ahead of the subject vehicle V in the traveling direction on the road 100 having one lane on each side. The example of FIG. 6B also illustrates a case where the alert target recognition unit 85 of the subject vehicle V has recognized this following vehicle V1 as an alert target and the alert control unit 86 executes the first alert control in order to alert the rider of the subject vehicle V about the presence of this alert target.

In a situation as illustrated in FIG. 6B, the preceding vehicle V5 present ahead of the subject vehicle V in the traveling direction becomes the movement triggering factor that triggers course changing of the subject vehicle V traveling in the normal traveling region R2 to the road shoulder region R1 side in a case where the rider of the subject vehicle V is in a hurry, in other words, in a case where a risk index for the preceding vehicle V5 is smaller than or equal to a predetermined threshold value. In the situation illustrated in FIG. 6B, the subject vehicle V and the following vehicle V1 might come into contact with each other when the subject vehicle V changes course to the road shoulder region R1 side in order to avoid contact with the preceding vehicle V5.

Thus, the course changing prediction unit 87 predicts that the subject vehicle V will change course from the normal traveling region R2 to the road shoulder region R1 in a case where the traveling position of the subject vehicle V is located in the normal traveling region R2, the preceding vehicle V5 as the movement triggering factor is present ahead of the subject vehicle V in the traveling direction, and further, the risk index for the preceding vehicle V5 calculated by the risk index calculation unit 84 is smaller than or equal to the predetermined threshold value while at least one alert target is recognized. In response to prediction of execution of course changing by the course changing prediction unit 87 while the first alert control for the following vehicle V1 is executed, the alert control unit 86 can execute the second alert control with a higher alert intensity to strongly cause the rider of the subject vehicle V to recognize the presence of the following vehicle V1 before starting course changing. This can avoid contact between the subject vehicle V and the following vehicle V1.

FIG. 6C is a view illustrating a third example of the movement triggering factor. FIG. 6C illustrates a case where the subject vehicle V is traveling in the second lane 202 in the normal traveling region R2, the following vehicle V1 which is going to overtake the subject vehicle V is traveling in the right alert region rearward on the right side, and further, the preceding vehicle V5 is traveling ahead of the subject vehicle V in the traveling direction on the road 200 having two lanes on each side. The example of FIG. 6C also illustrates a case where the alert target recognition unit 85 of the subject vehicle V has recognized this following vehicle V1 as an alert target and the alert control unit 86 executes the first alert control in order to alert the rider of the subject vehicle V about the presence of this alert target.

In a situation as illustrated in FIG. 6C, the preceding vehicle V5 present ahead of the subject vehicle V in the traveling direction becomes the movement triggering factor that triggers course changing of the subject vehicle V traveling in the second lane 202 to the first lane 201 side in a case where the rider of the subject vehicle V is in a hurry, in other words, in a case where the risk index for the preceding vehicle V5 is smaller than or equal to the predetermined threshold value. In the situation illustrated in FIG. 6C, the subject vehicle V and the following vehicle V1 might come into contact with each other when the subject vehicle V changes course to the first lane 201 side in order to avoid contact with the preceding vehicle V5.

Thus, the course changing prediction unit 87 predicts that the subject vehicle V will change course to an adjacent lane (the first lane 201 in the example of FIG. 6C) in the case where the traveling position of the subject vehicle V is located in the normal traveling region R2, the preceding vehicle V5 as the movement triggering factor is present ahead of the subject vehicle V in the traveling direction, and further, the risk index for the preceding vehicle V5 calculated by the risk index calculation unit 84 is smaller than or equal to the predetermined threshold value in a case where at least one alert target has been recognized and the subject vehicle V is traveling on a road having two or more lanes. In response to prediction of execution of course changing by the course changing prediction unit 87 while the first alert control for the following vehicle V1 is executed, the alert control unit 86 can execute the second alert control with a higher alert intensity to strongly cause the rider of the subject vehicle V to recognize the presence of the following vehicle V1 before starting course changing. This can avoid contact between the subject vehicle V and the following vehicle V1.

FIG. 6D is a view illustrating a fourth example of the movement triggering factor. FIG. 6D illustrates a case where the subject vehicle V is traveling in the normal traveling region R2, the following vehicle V1 is traveling in a left alert region rearward on the left side, the preceding vehicle V5 is traveling ahead of the subject vehicle V in the traveling direction, and further, a traffic light S is present ahead of the preceding vehicle V5 on the road 100 having one lane on each side. The example of FIG. 6D also illustrates a case where a display mode of the traffic light S represents no-entry or stop. The example of FIG. 6D also illustrates a case where the alert target recognition unit 85 of the subject vehicle V has recognized this following vehicle V1 as an alert target and the alert control unit 86 executes the first alert control in order to alert the rider of the subject vehicle V about the presence of this alert target.

In a situation as illustrated in FIG. 6D, the preceding vehicle V5 present ahead of the subject vehicle V in the traveling direction and the traffic light S become movement triggering factors that trigger course changing of the subject vehicle V traveling in the normal traveling region R2 to the road shoulder region R1 side in the case where the display mode of the traffic light S represents no-entry or stop. In the situation illustrated in FIG. 6D, the subject vehicle V and the following vehicle V1 might come into contact with each other when the subject vehicle V changes course to the road shoulder region R1 side in order to avoid contact with the preceding vehicle V5.

Thus, the course changing prediction unit 87 predicts that the subject vehicle V will change course from the normal traveling region R2 to the road shoulder region R1 in the case where the traveling position of the subject vehicle V is located in the normal traveling region R2, the preceding vehicle V5 and the traffic light S as the movement triggering factors are present ahead of the subject vehicle V in the traveling direction, and further, the display mode of the traffic light S represents no-entry or stop while at least one alert target is recognized. In response to prediction of execution of course changing by the course changing prediction unit 87 while the first alert control for the following vehicle V1 is executed, the alert control unit 86 can execute the second alert control with a higher alert intensity to strongly cause the rider of the subject vehicle V to recognize the presence of the following vehicle V1 before starting course changing. This can avoid contact between the subject vehicle V and the following vehicle V1.

FIG. 6E is a view illustrating a fifth example of the movement triggering factor. FIG. 6E illustrates a case where the subject vehicle V is traveling in the normal traveling region R2, the following vehicle V1 is traveling in a left alert region rearward on the left side, and the preceding vehicle V5 is traveling ahead of the subject vehicle V in the traveling direction on the road 100 having one lane on each side. The example of FIG. 6E also illustrates a case where the alert target recognition unit 85 of the subject vehicle V has recognized this following vehicle V1 as an alert target and the alert control unit 86 executes the first alert control in order to alert the rider of the subject vehicle V about the presence of this alert target.

In a situation as illustrated in FIG. 6E, the preceding vehicle V5 present ahead of the subject vehicle V in the traveling direction becomes the movement triggering factor that triggers course changing of the subject vehicle V traveling in the normal traveling region R2 to the road shoulder region R1 side in a case where a turn signal or a brake lamp of the preceding vehicle V5 is lit. In the situation illustrated in FIG. 6E, the subject vehicle V and the following vehicle V1 might come into contact with each other when the subject vehicle V changes course to the road shoulder region R1 side in order to avoid contact with the preceding vehicle V5.

Thus, the course changing prediction unit 87 predicts that the subject vehicle V will change course from the normal traveling region R2 to the road shoulder region R1 in the case where the traveling position of the subject vehicle V is located in the normal traveling region R2, the preceding vehicle V5 as the movement triggering factor is present ahead of the subject vehicle V in the traveling direction, and further, a turn signal or a brake lamp of the preceding vehicle V5 is lit while at least one alert target is recognized. In response to prediction of execution of course changing by the course changing prediction unit 87 while the first alert control for the following vehicle V1 is executed, the alert control unit 86 can execute the second alert control with a higher alert intensity to strongly cause the rider of the subject vehicle V to recognize the presence of the following vehicle V1 before starting course changing. This can avoid contact between the subject vehicle V and the following vehicle V1.

FIG. 6F is a view illustrating a sixth example of the movement triggering factor. FIG. 6F illustrates a case where the subject vehicle V is traveling in the second lane 202 in the normal traveling region R2, the following vehicle V1 which is going to overtake the subject vehicle V is traveling in a right alert region rearward on the right side, and further, the preceding vehicle V5 is traveling ahead of the subject vehicle V in the traveling direction on the road 200 having two lanes on each side. The example of FIG. 6F also illustrates a case where the alert target recognition unit 85 of the subject vehicle V has recognized this following vehicle V1 as an alert target and the alert control unit 86 executes the first alert control in order to alert the rider of the subject vehicle V about the presence of this alert target.

In a situation as illustrated in FIG. 6F, the preceding vehicle V5 present ahead of the subject vehicle V in the traveling direction becomes the movement triggering factor that triggers course changing of the subject vehicle V traveling in the second lane 202 to the first lane 201 side in the case where a turn signal or a brake lamp of the preceding vehicle V5 is lit. In the situation illustrated in FIG. 6F, the subject vehicle V and the following vehicle V1 might come into contact with each other when the subject vehicle V changes course to the first lane 201 side in order to avoid contact with the preceding vehicle V5.

Thus, the course changing prediction unit 87 predicts that the subject vehicle V will change course to an adjacent lane (the first lane 201 in the example of FIG. 6F) in the case where the traveling position of the subject vehicle V is located in the normal traveling region R2, the preceding vehicle V5 as the movement triggering factor is present ahead of the subject vehicle V in the traveling direction, and further, a turn signal or a brake lamp of the preceding vehicle V5 is lit in the case where at least one alert target has been recognized and the subject vehicle V is traveling on a road having two or more lanes. In response to prediction of execution of course changing by the course changing prediction unit 87 while the first alert control for the following vehicle V1 is executed, the alert control unit 86 can execute the second alert control with a higher alert intensity to strongly cause the rider of the subject vehicle V to recognize the presence of the following vehicle V1 before starting course changing. This can avoid contact between the subject vehicle V and the following vehicle V1.

An exception in the case where it is predicted that the subject vehicle V will change course from the normal traveling region R2 to the road shoulder region R1 as illustrated in FIG. 6B, FIG. 6D, and FIG. 6E will now be described. For example, in a case where the subject vehicle V travels at an edge of the normal traveling region R2 continuously for more than or equal to a predetermined time period, it is considered that the rider of the subject vehicle V is intentionally traveling at the edge of the normal traveling region R2 for traffic safety. Thus, in a case where the subject vehicle V travels continuously for more than or equal to a predetermined time period at a position in the normal traveling region R2 and within a predetermined distance a (see FIG. 6B) from the separation line L1 that separates the road shoulder region R1 and the normal traveling region R2, the course changing prediction unit 87 preferably predicts that the subject vehicle V will not change course from the normal traveling region R2 to the road shoulder region R1 even in the case where movement triggering factor/factors as illustrated in FIG. 6B, FIG. 6D, and FIG. 6E is/are recognized.

Referring back to FIG. 1, the case where the course changing prediction unit 87 predicts execution of course changing by the subject vehicle based on the surrounding information transmitted from the surrounding information acquisition unit 81, the risk index calculated by the risk index calculation unit 84, and the like has been described, but the present invention is not limited to this. The course changing prediction unit 87 may predict execution of course changing by the subject vehicle based on a result of learning of the traveling position of the subject vehicle in the road width direction by the traveling position learning unit 88 which will be described later in addition to the surrounding information and the risk index. The course changing prediction unit 87 can thereby predict execution of course changing of the subject vehicle in consideration of a driving tendency of the rider of the subject vehicle, which can improve prediction accuracy.

The traveling position learning unit 88 learns the traveling position of the subject vehicle in the road width direction based on the surrounding information transmitted from the surrounding information acquisition unit 81 and the traveling position information transmitted from the traveling position specification unit 83. More specifically, the traveling position learning unit 88 learns the traveling position of the subject vehicle for each of various traffic scenes categorized depending on the form of the road, a surrounding traffic situation, and the like. The traveling position learning unit 88 transmits information related to the result of learning of the traveling position of the subject vehicle to the course changing prediction unit 87.

FIG. 7A and FIG. 7B are flowcharts illustrating a specific procedure of alert processing of alerting the rider of the subject vehicle about the presence of another vehicle approaching from laterally behind. The processing illustrated in FIG. 7A and FIG. 7B is executed by the driving support control device 8 in a predetermined cycle during traveling of the subject vehicle.

First, in step ST1, the surrounding information acquisition unit 81 acquires surrounding information related to a state of surroundings of the subject vehicle based on a detection result obtained by the outside sensor unit 2, and the process transitions to step ST2. In step ST2, the traveling position specification unit 83 specifies the traveling position of the subject vehicle on the road on which the subject vehicle is traveling based on the surrounding information, and the process transitions to step ST3.

In step ST3, the alert target recognition unit 85 zones a left alert region and a right alert region in a range in accordance with the traveling position of the subject vehicle based on the surrounding information and the traveling position of the subject vehicle following the procedure described with reference to FIG. 4A to FIG. 4C and FIG. 5A to FIG. 5C, and the process transitions to step ST4.

In step ST4, the alert target recognition unit 85 determines whether or not another vehicle is present in at least either of the right and left alert regions zoned in step ST3 based on the surrounding information. In a case where a result of the determination in ST4 is NO, the driving support control device 8 terminates the alert processing. In a case where the result is YES, the process transitions to step ST5.

In step ST5, the risk index calculation unit 84 calculates a risk index for the other vehicle determined to be present in at least either of the alert regions in step ST4, and the process transitions to step ST6. In step ST6, the alert target recognition unit 85 determines whether or not the risk index for the other vehicle calculated in step ST5 is smaller than or equal to a predetermined threshold value. In a case where a result of the determination in step ST6 is NO, the driving support control device 8 terminates the alert processing. In a case where the result is YES, the process transitions to step ST7.

In step ST7, the alert target recognition unit 85 recognizes the other vehicle present in at least either of the alert regions and having the risk index smaller than or equal to the threshold value as an alert target, and the process transitions to step ST8. In step ST8, the alert control unit 86 executes the first alert control in order to alert the rider of the subject vehicle about the presence of the alert target recognized in step ST7, and the process transitions to step ST10.

In step ST10, the alert control unit 86 determines whether or not a turn signal switch on the side where the alert target is present has been operated by the rider of the subject vehicle. In a case where a result of the determination in step ST10 is NO, the process transitions to step ST11.

In a case where the result of the determination in step ST10 is YES, the alert control unit 86 determines that the subject vehicle which is going to change the traveling direction and the alert target approaching from behind might come into contact with each other, and the process transitions to step ST20. In step ST20, the alert control unit 86 executes the second alert control, and the driving support control device 8 terminates the alert processing.

In step ST11, the course changing prediction unit 87 determines whether or not the traveling position of the subject vehicle is located in the road shoulder region and an obstacle as a movement triggering factor is present ahead of the subject vehicle in the traveling direction as described with reference to FIG. 6A. In a case where a result of the determination in step ST11 is YES, the course changing prediction unit 87 determines that the subject vehicle will change course from the road shoulder region to the normal traveling region, and the process transitions to step ST20. In a case where the result of the determination in step ST11 is NO, the process transitions to step ST12.

In step ST12, the course changing prediction unit 87 determines whether or not the traveling position of the subject vehicle is located in the normal traveling region, another vehicle and a traffic light as movement triggering factors are present ahead of the subject vehicle in the traveling direction, and further, the display mode of the traffic light represents no-entry or stop as described with reference to FIG. 6D. In a case where a result of the determination in step ST12 is YES, the course changing prediction unit 87 determines that the subject vehicle will change course from the normal traveling region to the road shoulder region, and the process transitions to step ST20. In a case where the result of the determination in step ST12 is NO, the process transitions to step ST13.

In step ST13, the course changing prediction unit 87 determines whether or not the traveling position of the subject vehicle is located in the normal traveling region, another vehicle as a movement triggering factor is present ahead of the subject vehicle in the traveling direction, and further, a turn signal or a brake lamp of the other vehicle present ahead is lit as described with reference to FIG. 6E and FIG. 6F. In a case where a result of the determination in step ST13 is YES, the course changing prediction unit 87 determines that the subject vehicle will change course from the normal traveling region to the road shoulder region, and the process transitions to step ST20. In a case where the result of the determination in step ST13 is NO, the process transitions to step ST14.

In step ST14, the course changing prediction unit 87 determines whether or not the traveling position of the subject vehicle is located in the normal traveling region, another vehicle as a movement triggering factor is present ahead of the subject vehicle in the traveling direction, and further, the risk index for the other vehicle is smaller than or equal to the predetermined threshold value as described with reference to FIG. 6B and FIG. 6C. In a case where a result of the determination in step ST14 is YES, the course changing prediction unit 87 determines that the subject vehicle will change course from the normal traveling region to the road shoulder region, and the process transitions to step ST20. In a case where the result of the determination in step ST14 is NO, the driving support control device 8 terminates the alert processing.

The driving support system 1 according to the present embodiment exerts the following effects.

(1) In the driving support system 1, the surrounding information acquisition unit 81 acquires surrounding information related to a state of surroundings of the subject vehicle, the alert target recognition unit 85 recognizes another vehicle present in an alert region defined to be laterally behind the subject vehicle as an alert target, and the alert control unit 86 performs the first alert control of alerting a driver of the subject vehicle about the presence of the alert target. Based on the surrounding information, the course changing prediction unit 87 predicts execution of course changing by the subject vehicle to be performed while the alert target is recognized. Herein, in the case where the subject vehicle is one that can travel on the road shoulder, such as a motorcycle, the driver of the subject vehicle in some cases enters/exits the road shoulder without activating the turn signal 6L or 6R as described above. The driving support system 1 addresses this, and the alert control unit 86 performs the second alert control with a higher alert intensity than the first alert control in the case where execution of course changing is predicted based on the surrounding information while the first alert control is performed, in other words, while the presence of the alert target is recognized. Therefore, according to the driving support system 1, the alert control unit 86 performs the second alert control with a higher alert intensity in the case where the driver of the subject vehicle is going to change course without recognizing the presence of the alert target and without activating the turn signal 6L or 6R. This enables the driver of the subject vehicle to recognize the presence of the alert target before actually changing course of the vehicle body, which in turn can improve traffic safety.

(2) Based on the surrounding information, the course changing prediction unit 87 predicts execution of course changing by the subject vehicle in the case where it is recognized that the movement triggering factor that triggers a movement of the subject vehicle in the width direction is present ahead of the subject vehicle in the traveling direction. Therefore, according to the driving support system 1, the second alert control can be performed before the vehicle body of the subject vehicle actually starts a course changing motion. This can ensure a sufficient time period for the rider to determine the appropriateness of execution of course changing while seeing a surrounding situation.

(3) The course changing prediction unit 87 predicts that the subject vehicle will change course from the road shoulder region R1 to the normal traveling region R2 in the case where it is recognized that the traveling position of the subject vehicle is located in the road shoulder region R1 and the obstacle O1 as the movement triggering factor is present ahead of the subject vehicle in the traveling direction. Therefore, according to the driving support system 1, the second alert control can be performed before the vehicle body of the subject vehicle actually starts the course changing motion for avoiding contact with the obstacle O1 present ahead. This can ensure a sufficient time period for the driver to determine the appropriateness of execution of course changing while seeing a surrounding situation.

(4) The course changing prediction unit 87 predicts that the subject vehicle will change course so as to avoid contact with the preceding vehicle in the case where the traveling position of the subject vehicle is located in the normal traveling region R2, a preceding vehicle as the movement triggering factor is present ahead of the subject vehicle in the traveling direction, and the risk index for this preceding vehicle is smaller than or equal to the predetermined threshold value. Therefore, according to the driving support system 1, the second alert control can be performed before the vehicle body of the subject vehicle actually starts the course changing motion for avoiding contact with the preceding vehicle. This can ensure a sufficient time period for the driver to determine the appropriateness of execution of course changing while seeing a surrounding situation.

(5) The course changing prediction unit 87 predicts execution of course changing by the subject vehicle in the case where the traveling position of the subject vehicle is located in the normal traveling region R2, a preceding vehicle and the traffic light S as the movement triggering factors are present ahead of the subject vehicle in the traveling direction, and the display mode of the traffic light S represents no-entry or stop. Therefore, according to the driving support system 1, the second alert control can be performed before the vehicle body of the subject vehicle actually starts the course changing motion for avoiding contact with the preceding vehicle which is going to stop. This can ensure a sufficient time period for the driver to determine the appropriateness of execution of course changing while seeing a surrounding situation.

(6) The course changing prediction unit 87 predicts execution of course changing by the subject vehicle in the case where the traveling position of the subject vehicle is located in the normal traveling region R2, a preceding vehicle as a movement triggering factor is present ahead of the subject vehicle in the traveling direction, and a brake lamp of the preceding vehicle is lit. Therefore, according to the driving support system 1, the second alert control can be performed before the vehicle body of the subject vehicle actually starts the course changing motion for avoiding contact with the preceding vehicle which is going to stop. This can ensure a sufficient time period for the driver to determine the appropriateness of execution of course changing while seeing a surrounding situation.

(7) The course changing prediction unit 87 predicts execution of course changing by the subject vehicle in the case where the traveling position of the subject vehicle is located in the normal traveling region R2, a preceding vehicle as the movement triggering factor is present ahead of the subject vehicle in the traveling direction, and a turn signal of the preceding vehicle is lit. Therefore, according to the driving support system 1, the second alert control can be performed before the vehicle body of the subject vehicle actually starts the course changing motion for avoiding contact with the preceding vehicle which is going to change course. This can ensure a sufficient time period for the driver to determine the appropriateness of execution of course changing while seeing a surrounding situation.

(8) The alert target recognition unit 85 changes the widthwise length of the alert region depending on the traveling position of the subject vehicle in the case where the normal traveling region R2 is separated into two or more lanes as illustrated in FIG. 4A to FIG. 4C and FIG. 5A to FIG. 5C. This can prevent alerting from being frequently executed due to recognition of another vehicle traveling in a lane in which the rider has no intention to travel as an alert target to bother the rider.

(9) In the case where the traveling position is located in the road shoulder region R1 or the traveling position is located near a lane edge of a lane, the alert target recognition unit 85 makes the widthwise length of the alert region shorter than in the case where the traveling position is located at the center of a lane as illustrated in FIG. 4A to FIG. 4C and FIG. 5A to FIG. 5C. This can prevent alerting from being frequently executed due to recognition of another vehicle traveling in a lane in which the rider has no intention to travel as an alert target to bother the rider.

(10) The course changing prediction unit 87 determines that the rider of the subject vehicle has no intention to enter the road shoulder region R1 and predicts that the subject vehicle will not change course from the normal traveling region R2 to the road shoulder region R1 in the case where the subject vehicle travels in the normal traveling region R2 and within the predetermined distance a (see FIG. 6B) from the separation line L1 that separates the road shoulder region R1 and the normal traveling region R2 continuously for more than or equal to the predetermined time period. Therefore, the driving support system 1 can prevent the second alert control from being frequently performed for the rider having no intention to travel in the road shoulder region R1 to bother the rider.

(11) The traveling position learning unit 88 leans the traveling position of the subject vehicle in the road width direction, and the course changing prediction unit 87 predicts execution of course changing based on the surrounding information and a result of learning performed by the traveling position learning unit 88. Therefore, according to the driving support system 1, execution of course changing can be predicted in consideration of the tendency of traveling positions in the past, so that timing at which the second alert control is executed can be made suitable for the rider.

(12) Saddle type vehicles such as motorcycles and buggies are smaller in vehicle width and lighter in weight than four-wheeled vehicles and thus in some cases enter/exit the road shoulder without activating a turn signal. Therefore, according to the present invention, the first alert control and the second alert control are performed for such a saddle type vehicle through the procedure as described above, thereby enabling traffic safety to be improved.

Although an embodiment of the present invention has been described above, the present invention is not limited to this. Detailed configuration may be changed as appropriate within the scope of the present invention.

What is claimed is:

1. A driving support system comprising:
a surrounding information acquirer configured to acquire surrounding information related to a state of surroundings of a subject vehicle;
an alert target recognizer configured to, based on the surrounding information, recognize another vehicle present in an alert region defined to be laterally behind the subject vehicle as an alert target;
an alert controller configured to, in a case where the alert target is recognized, perform first alert control of alerting a driver of the subject vehicle about a presence of the alert target; and
a course changing predictor configured to, based on the surrounding information, predict execution of course changing by the subject vehicle to be performed while the alert target is recognized, wherein
the alert controller performs second alert control with a higher alert intensity than the first alert control in a case where execution of the course changing is predicted by the course changing predictor while the first alert control is performed.

2. The driving support system according to claim 1, wherein the course changing predictor predicts execution of the course changing based on the surrounding information in a case where it is recognized that a movement triggering factor that triggers a movement of the subject vehicle in a width direction is present ahead of the subject vehicle in a traveling direction.

3. The driving support system according to claim 2, further comprising a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, wherein
the course changing predictor predicts that the subject vehicle will change course from the road shoulder region to the normal traveling region in a case where it is recognized that the traveling position is located in the road shoulder region and an obstacle as the movement triggering factor is present ahead of the subject vehicle in the traveling direction.

4. The driving support system according to claim 2, further comprising:
a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road; and
a risk index calculator configured to, in a case where a preceding vehicle is present ahead of the subject vehicle in the traveling direction, calculate a risk index based on the surrounding information, the risk index decreasing as a risk that the subject vehicle will come into contact with the preceding vehicle increases, wherein
the course changing predictor predicts execution of the course changing in a case where the traveling position is located in the normal traveling region, the preceding vehicle as the movement triggering factor is present ahead of the subject vehicle in the traveling direction, and the risk index for the preceding vehicle is smaller than or equal to a predetermined threshold value.

5. The driving support system according to claim 2, further comprising a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, wherein
the course changing predictor predicts execution of the course changing in a case where the traveling position is located in the normal traveling region, the movement triggering factor comprises movement triggering factors, a preceding vehicle and a traffic light as the movement triggering factors are present ahead of the subject vehicle in the traveling direction, and a display mode of the traffic light represents no-entry or stop.

6. The driving support system according to claim 2, further comprising a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, wherein
the course changing predictor predicts execution of the course changing in a case where the traveling position is located in the normal traveling region, a preceding vehicle as the movement triggering factor is present ahead of the subject vehicle in the traveling direction, and a brake lamp of the preceding vehicle is lit.

7. The driving support system according to claim 2, further comprising a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, wherein
the course changing predictor predicts execution of the course changing in a case where the traveling position is located in the normal traveling region, a preceding vehicle as the movement triggering factor is present ahead of the subject vehicle in the traveling direction, and a turn signal of the preceding vehicle is lit.

8. The driving support system according to claim 3, wherein the alert target recognizer changes a widthwise length of the alert region depending on the traveling position in a case where the normal traveling region is separated into two or more lanes.

9. The driving support system according to claim 8, wherein in a case where the traveling position is located in the road shoulder region or in a case where the traveling position is located at a lane edge of one of the lanes, the alert target recognizer makes the widthwise length of the alert region shorter than in a case where the traveling position is located at a center of one of the lanes.

10. The driving support system according to claim 2, further comprising a traveling position specifier configured to separate a road on which the subject vehicle travels into a road shoulder region within a predetermined width from a widthwise edge of the road and a normal traveling region adjacent to the road shoulder region, and specify a traveling position of the subject vehicle on the road, wherein
the course changing predictor predicts that the subject vehicle will not change course from the normal traveling region to the road shoulder region in a case where the subject vehicle travels in the normal traveling region and within a predetermined distance from a line that separates the road shoulder region and the normal traveling region continuously for more than or equal to a predetermined time period.

11. The driving support system according to claim 1, further comprising a traveling position learner configured to learn a traveling position of the subject vehicle in a road width direction, wherein
the course changing predictor predicts execution of the course changing based on the surrounding information and a result of learning performed by the traveling position learner.

12. The driving support system according to claim 1, wherein the subject vehicle is a saddle type vehicle.
